(19) United States
(12) Patent Application Publication
(10) Pub. No.: US 2014/0333481 A1
(43) Pub. Date: Nov. 13, 2014

(54) METHOD FOR LOCATING THE POSITION OF A VEHICLE

(71) Applicant: DATASPEED INC., Troy, MI (US)

(72) Inventors: Paul Fleck, Troy, MI (US); Micho Radovnikovich, Shelby Township, MI (US); Ka C. Cheok, Waterford, MI (US); Steve Grzebyk, Shelby Township, MI (US); Kevin Hallenbeck, Metamora, MI (US)

(73) Assignee: DATASPEED INC., Troy, MI (US)

(21) Appl. No.: 14/266,875

(22) Filed: May 1, 2014

Related U.S. Application Data
(60) Provisional application No. 61/821,554, filed on May 9, 2013.

(51) Int. Cl. G01S 5/06

(52) U.S. Cl. CPC G01S 5/06
USPC 342/463

(57) ABSTRACT

A method for locating the position of a vehicle having a transceiver. An estimate of the position of the vehicle is first determined by using at least three spaced apart receivers by performing trilateration with the three receivers. Thereafter, two of the receivers which intersect the vehicle at an angle closest to 90 degrees at a solution closest to the estimate of the vehicle position is used to perform implicit triangulation of the vehicle position using only the two receivers. The new position of the vehicle is used to update the estimated vehicle position.

### CROSS-REFERENCE TO RELATED APPLICATIONS

This application claims priority of U.S. Provisional Application 61/821,554 filed May 9, 2013, the contents of which are incorporated herein by reference.

### BACKGROUND OF THE INVENTION

I. Field of the Invention

The present invention relates generally to a method for identifying the position of an automated vehicle in a known space.

II. Description of Related Art

There are a number of previously known ways for establishing navigation of autonomous factory vehicles. Some systems involve the use of magnetic tape paths while other others use laser or other optical localization systems.

These previously known techniques, however, require extensive and expensive infrastructure. Furthermore, such infrastructure is not easily reconfigured which limits the usefulness of this technology.

In recent years, ultra wideband (UWB) based localization systems have become feasible to implement real-world indoor localization applications, and especially applications involving autonomous factory vehicles. The UWB localization typically focuses on the signal processing of the UWB radio signals which are susceptible to multipath reflection. In many cases, the time difference of arrival (TDOA) method of localization is used in which a target radio transmits a pulse that each of the base radios receive. Based on the different arrival times of the radio packet, the position of the target radio, typically mounted on the autonomous factory vehicle, can be computed.

Still other approaches use the time of arrival (TOA) method to determine the position of the vehicle. In TOA, the time of flight of the radio packet is explicitly measured and converted into a corresponding range using the known speed of light.

All these previously known methods, however, utilize three separate fixed radio receivers in order to locate the position of the vehicle. The requirement of three separate radio receivers in the factory setting, however, increases the time required to perform the ranging measurements. Furthermore, since the autonomous factory vehicles are oftentimes moving, the time delay of these previously known systems which require three factory receivers to locate the vehicle results in inaccurate position determination due to the time lapse required to calculate the vehicle position.

### SUMMARY OF THE PRESENT INVENTION

The present invention overcomes the previously known methods for determining the position in a known space of a vehicle that overcomes the previously known disadvantage of the previously known methods.

In brief, the vehicle includes a transceiver which both receives and transmits signals. Additionally, at least three receivers are positioned in known locations in a known space, such as the interior of a factory.

First, it is determined if an estimate of the vehicle position is known and, if not, an estimate of the vehicle position is obtained by performing trilateration using at least three of the fixed receivers in the known space. Such trilateration is performed using conventional and well-known techniques.

After the estimate of the vehicle position is obtained, two of the at least three receivers are identified which intersect the vehicle at an angle closest to 90 degrees and at a solution closest to the estimate of the vehicle position. Implicit triangulation is then performed using the two identified receivers to compute the vehicle position and the result is then used to update the estimate of the computed vehicle position.

The above process is iteratively repeated for each autonomous factory vehicle. Furthermore, since the vehicle position is determined using only two receivers after the initial estimate of the vehicle position is determined through trilateration, the position of the vehicle is determined much more rapidly by reducing the time required to perform the range measurements.

### BRIEF DESCRIPTION OF THE DRAWING

A better understanding of the present invention will be had upon reference to the following detailed description when read in conjunction with the accompanying drawing, wherein like reference characters refer to like parts throughout the several views, and in which:

FIG. 1 is a top diagrammatic view illustrating the identification of the position of an autonomous factory vehicle using trilateration;

FIG. 2 is a view similar to FIG. 1, but illustrating diagrammatically the identification of the position of the autonomous factory vehicle using implicit triangulation;

FIG. 3 is a flowchart illustrating the method of the present invention; and

FIG. 4 is a graph illustrating range filtering.

FIG. 5 is a graph illustrating the implicit triangulation.

### DETAILED DESCRIPTION OF A PREFERRED EMBODIMENT OF THE PRESENT INVENTION

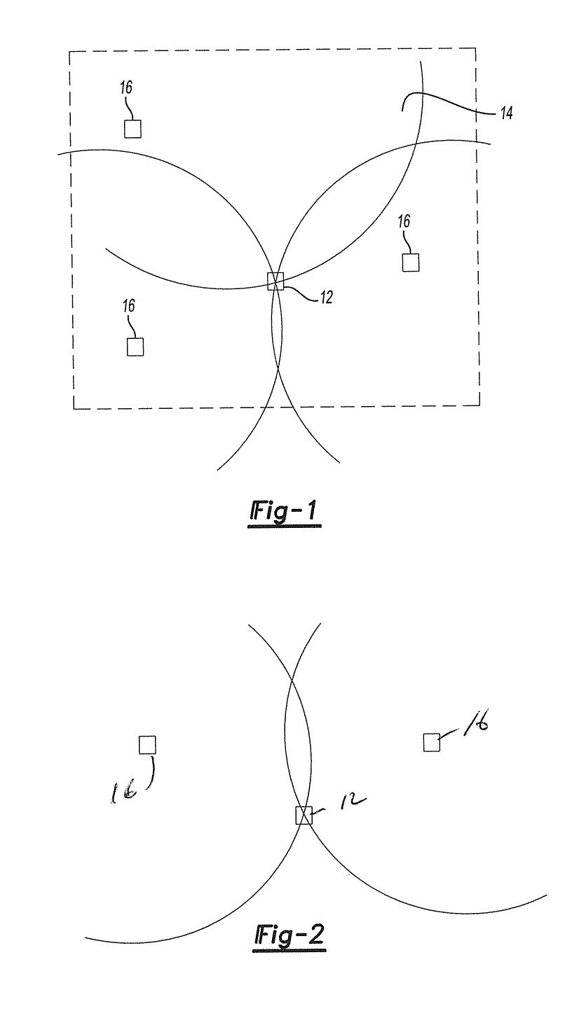

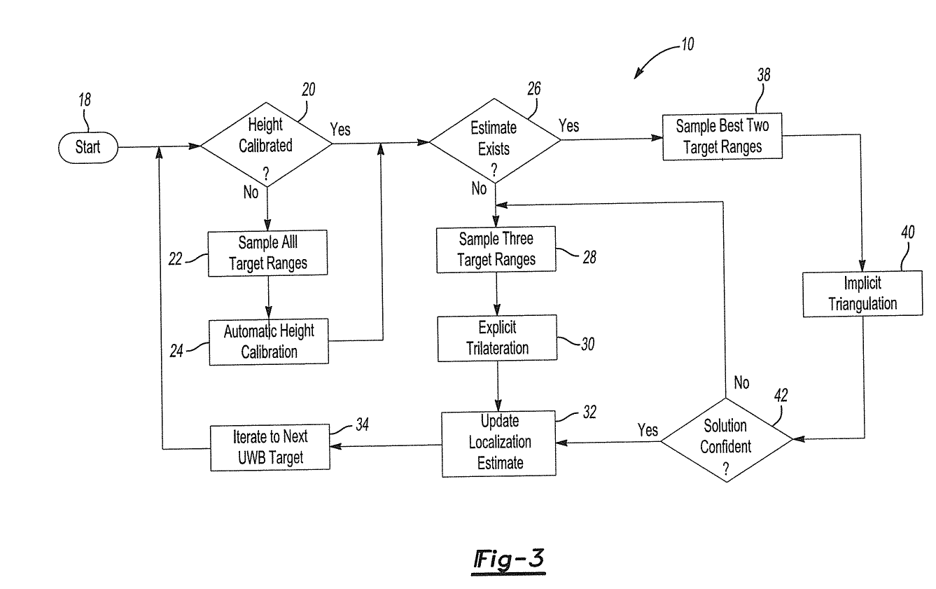

With reference first to FIG. 3, a flowchart 10 illustrating the method of the present invention is shown. As will become hereinafter more readily apparent, the method of the present invention allows the position of an autonomous factory vehicle to be rapidly computed using an ultra wideband based localization system. For example, as shown in FIG. 1, an autonomous factory vehicle 12 is positioned at an unknown position within a predefined space 14, such as the interior of a factory. At least three radio receivers 16 are also contained within the space 14 at fixed and known positions. The radios 16 are spaced apart from each other and as many radios are employed as necessary to cover the space 14. Consequently, with larger spaces, more radios 16 will be used, and vice versa.

After initiation of the method at step 18, step 18 proceeds to step 20. At step 20, it is determined if the height of the transceiver carried by the autonomous factory vehicle 12 relative to the height of the fixed factory receiver 16 had been accounted for in the TDOA calculations. If not, step 20 proceeds to step 22 where the height of the transceiver on all the factory vehicles 12 is obtained. Step 22 then proceeds to step 24 where the TDOA calculations are calibrated by taking into account the height of the vehicle transceivers. For example, whenever a range to a target is made, the time stamp, base radio 16 ID, and the target radio 12 ID are recorded along with it. The next time a range is made with the same base and target IDs, an implied velocity is computed in accordance with the following formula:

$${v}_{k} = \frac{{r}_{k} - {r}_{k - 1}}{{t}_{k} - {t}_{k - 1}}$$

where rₖ is the current range sample, rₖ₋ₗ is the previous range sample, and tₖ and tₖ₋ₗ are the time stamps.

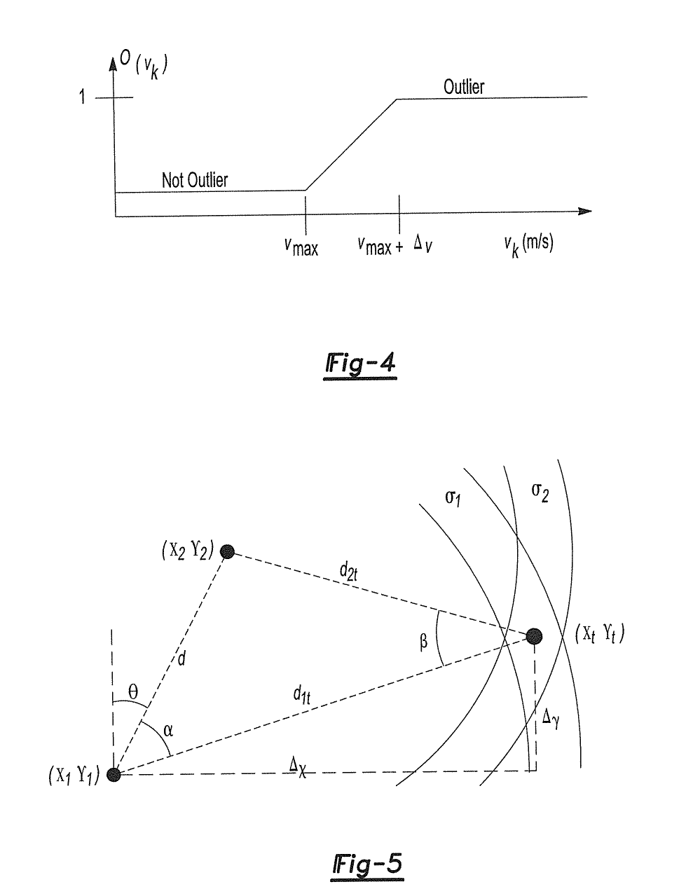

If the implied velocity is very large, the current range measurement is most likely incorrect. However, by putting a maximum limit vₘₐₓ on the velocity of the target 12, a simple fuzzy logic membership function O(vₖ) can be constructed to classify a given range measurement as an outlier as shown in FIG. 4.

During the calibration of the height in step 24, it is quite possible that the height of the various radios 16 differ from each other. Consequently, the filtered line-of-sight range measurements \hat{r} are projected into a lateral range measurement by

l=\sqrt{r²−Δh²}

where Δh is the height difference between the two radios involved in the range measurement.

After the completion of the height calibration at step 24, step 24 proceeds to step 26. Furthermore, since the height of the fixed radios 16 never change, the height calibration at step 24 needs to be performed only a single time.

At step 26, it is determined if an estimate of the position of the vehicle 12 is known. If not, step 26 proceeds to step 28 to sample the three targets and then to step 30 to perform the trilateration illustrated in FIG. 1. In such trilateration, the distance from each of the at least three radio receivers 16 to the vehicle 12 which intersect each other at the position of the vehicle 12. Thus, although two separate solutions exist for each of the three pair of receivers 16, only a single solution of the vehicle position exists for a trilateration using three or more radio receivers 16.

In performing the trilateration, if the geometry of the base radios is known and ranges from three different base radios are sampled, the 2-D position of the target can be solved in closed form by

$$[ \begin{matrix}{x}_{t} \\ {y}_{t}\end{matrix} ] = {[ \begin{matrix}{x}_{2} - {x}_{1} & {y}_{2} - {y}_{1} \\ {x}_{3} - {x}_{2} & {y}_{3} - {y}_{2} \\ {x}_{1} - {x}_{3} & {y}_{1} - {y}_{3}\end{matrix} ]}^{+} [ \begin{matrix}( {x}_{2}^{2} - {x}_{1}^{2} ) + ( {y}_{2}^{2} - {y}_{1}^{2} ) - ( {l}_{2 t}^{2} - {l}_{1 t}^{2} ) \\ ( {x}_{3}^{2} - {x}_{2}^{2} ) + ( {y}_{3}^{2} - {y}_{2}^{2} ) - ( {l}_{3 t}^{2} - {l}_{2 t}^{2} ) \\ ( {x}_{1}^{2} - {x}_{3}^{2} ) + ( {y}_{1}^{2} - {y}_{3}^{2} ) - ( {l}_{1 t}^{2} - {l}_{3 t}^{2} )\end{matrix} ]$$

where (xₗ,yₗ) is the estimate of the target's position, (x_{1,2,3},y_{1,2,3}) are the coordinates of the three base radios, and lᵢₗ are the lateral range measurements between base radio i and the target. The + operator represents the Moore-Penrose pseudo inverse, where [•]⁺=([•]^{T}[•])⁻¹[•]^{T}. Step 30 then proceeds to step 32.

At step 32, an estimate of the position of the vehicle 12 is updated and stored. Step 32 then proceeds to step 34 where the next UWB target or vehicle 12 is obtained, assuming multiple vehicles 12, and the above process is then repeated for each autonomous vehicle in the system. In this fashion an estimated position is obtained for all of the factory vehicles 12.

After the height calculation for the fixed receivers 16 and an estimated position for all of the vehicles 12 in the system have been obtained, step 26 proceeds to step 38. At step 38 two receivers are selected to perform a subsequent implicit triangulation with maximum accuracy.

FIG. 5 shows the geometry involved in the implicit triangulation between some pair of base radios at coordinates (x₁,y₁) and (x₂,y₂) and a target radio. If there are n base radios, then there are N=Σᵢ₌₁ⁿ⁻¹i unique triangles that include two base radios and the target radio.

It is desired to select the triangle that yields the smallest intersection area between the range uncertainty annuli shown in FIG. 3, where the radius differences are the standard deviations of the range measurements, σ₁ and σ₂. The intersection area is minimized if the angle β is equal to π/2 radians, so the base radios that yield the β closest to π/2 is used, where

$$β = {cos}^{- 1} ( \frac{{d}_{1 t}^{2} + {d}_{2 t}^{2} - {d}^{2}}{2 {d}_{1 t} {d}_{2 t}} )$$

The algorithm for finding the optimal pair of radios is outlined in Algorithm 1.

Algorithm 1—Find the best two radios for triangulation.

| | |
|---|---|
| 1: βₒₚₜ ← 0 | [symbol] Initialize optimal β |

| 2: for each unique pair of base radios | |
|---|---|
| 3: | (x₁, y₁) and (x₂, y₂) do |

| | |
|---|---|
| 4: | d ← \sqrt{(x₂ − x₁)² + (y₂ − y₁)²} |
| 5: | d₁ₜ ← \sqrt{(x₁ − x₁)² + (y₁ − y₁)²} |
| 6: | d₂ₜ ← \sqrt{(x₁ − x₂)² + (y₁ − y₂)²} |
| 7: | Compute β from (3) |
| 8: | if \|β − π/2\| < \|βₒₚₜ − π/2\| then |

| | | |
|---|---|---|
| 9: | βₒₚₜ ← β | [symbol] New β closer to π/2 |

| | |
|---|---|
| 10: | end if |

11: end for
12: return (x₁, y₁) and (x₂, y₂) corresponding to βₒₚₜ

After the optimal pair of base radios 16 is selected, the lateral ranges l₁ₗ and l₂ₗ to the target are sampled, and the θ and α angles are computed by

$$θ = atan 2 ( {x}_{2} - {x}_{1} , {y}_{2} - {y}_{1} )$$

$$α = {cos}^{- 1} ( \frac{{l}_{1 t}^{2} + {l}_{2 t}^{2} - {d}^{2}}{2 {l}_{1 t} {l}_{2 t}} )$$

After computing θ and α, Δx and Δy are given by

Δx=l₁ₗ sin(θ±α), Δy=l₁ₗ cos(θ±α)

Each of the two solutions for Δx and Δy are added to (x₁,y₁) to get the new localization estimate. This multi-valued solution is resolved by taking the one that is close to the previous estimate.

After the implicit triangulation at step 40, step 40 proceeds to step 42 in which the position of the vehicle 12 is compared with the prior estimated position of the vehicle. If that difference exceeds a predetermined threshold, there is a lesser confidence that the implicit triangulation 40 is accurate, i.e. the wrong solution of two possible solutions may have been selected. In this event, step 42 proceeds back to step 28 and then to step 30 where an explicit trilateration is again performed using three different factory radios 16.

One algorithm to perform localization by using implicit triangulation is as follows:

Algorithm 2—Localization using implicit triangulation.

| 1: Input: (x_{t,k-1}, y_{t,k-1}), (x₁, y₁) and (x₂, y₂) | | |
|---|---|---|
| 2: Sample lateral ranges l₁ₜ and l₂ₜ | | |
| 3: Compute θ and α from (4) and (5) | | |
| 4: Δx⁺ ← l₁ₜ sin(θ + α), Δy⁺ ← l₁ₜ cos(θ + α) | | |
| 5: Δx⁻ ← l₁ₜ sin(θ − α), Δy⁻ ← l₁ₜ cos(θ − α) | | |
| 6: d⁺ ← \sqrt{(x_{t,k-1} − x₁ − Δx⁺)² + (y_{t,k-1} − y₁ − Δy⁺)²} | | |
| 7: d⁻ ← \sqrt{(x_{t,k-1} − x₁ − Δx⁻)² + (y_{t,k-1} − y₁ − Δy⁻)²} | | |
| 8: if min (d⁺, d⁻) > ∈, then | | |
| 9: | return | [symbol] Abort and do explicit trilateration |

| 10: end if | |
|---|---|
| 11: if d⁺ < d⁻ then | |
| 12: | x_{t,k} ← x₁ + Δx⁺, y_{t,k} ← y₁ + Δy⁺ |
| 13: else | |
| 14: | x_{t,k} ← x₁ + Δx⁻, y_{t,k} ← y₁ + Δy⁻ |

15: end if
16: return (x_{t,k}, y_{t,k})

It will be understood, of course, that the position of all of the factory autonomous vehicles are iteratively determined, and their estimated positions updated, during the operation of the system.

From the foregoing, it can be seen that the present invention provides a method, implemented by a programmed processor, to quickly obtain the position of an autonomous factory vehicle utilizing two fixed radios and implicit triangulation. Since the use of only two fixed radios reduces the time required for ranging measurements, numerous autonomous factory vehicles may be simultaneously tracked within the factory space.

Having described my invention, however, many modifications thereto will become apparent to those skilled in the art to which it pertains without deviation from the spirit of the invention as defined by the scope of the appended claims.

I claim:

1. A method using a programmed processor for locating the position in a known space of a vehicle having a transceiver and at least three receivers in known locations in said known space, said method comprising the steps of:
determining if an estimate of the vehicle position is known and, if not, obtaining an estimate by performing trilateration using the at least three receivers,
identifying two of the at least three receivers which intersect the vehicle at an angle closest to 90 degrees at a solution closest to said estimate of said vehicle position,
performing implicit triangulation to compute the vehicle position using said two receivers,
updating said estimate with said computed vehicle position.

2. The method as defined in claim 1 and further comprising the steps of:
computing the difference between the computed vehicle position with the prior estimate of the vehicle position,
performing trilateration using at least three receivers to compute a new estimate of the vehicle position whenever said difference exceeds a predetermined threshold.

3. The method as defined in claim 1 wherein said trilateration step comprises the step of adjusting the distance between each receiver and the vehicle to reflect height variations between said at least three receivers and the vehicle.

4. The method as defined in claim 1 where said trilateration step is performed by ultra wideband ranging technology.
